(19) United States
(12) Patent Application Publication
(10) Pub. No.: US 2002/0032679 A1
(43) Pub. Date: Mar. 14, 2002

(54) Method for providing information at an engineering portal site

(76) Inventors: Yasuo Hira, Mito (JP); Masaaki Sato, Fujisawa (JP); Motomi Odamura, Hitachinaka (JP); Tsutomu Sakamoto, Yokohama (JP); Sakee Nemoto, Kamakura (JP); Teruo Kumagai, Tokai (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/923,427

(22) Filed: Aug. 8, 2001

(30) Foreign Application Priority Data
Sep. 8, 2000 (JP) 2000-278674

(51) Int. Cl. G06F 7/00

(52) U.S. Cl. 707/3; 707/10

(57) ABSTRACT

When the user enters a problem, data of the problem is sent to a server, which searches a case database or a meta database concerning solutions. This meta database has database including actual examples of solution collected according to each of rules into which the solutions to the past problems are classified, which past problems are considered as opposed concepts of physical or chemical laws. Since this meta database is based on, for example, laws of nature extracted from problems, it is possible to propose such a solution as to be rarely used or not to have been used so far depending on the field.

### BACKGROUND OF THE INVENTION

The present invention relates to a method and system for providing information that makes it easy to find a new solution to a problem the user has.

Digital content sale systems for selling various contents have so far been proposed. For example, JP-A-11-345261 discloses a content management system and recording medium for making it possible that the utilization license for sending contents from a terminal and the results of the utilization are sent to and managed in a central apparatus so as to enable the sale management and utilization management for each content.

On the other hand, research and development institutions of various kinds of enterprises and universities have made many technology developments. The knowledge obtained from those technology developments are generally known by news release and publication in academic journals. Some of such knowledge is kept in secrecy in order to maintain the competitiveness against other research and development institutions and to be utilized for various kinds of future business or is used within the associated institution for the reason of being developing that technology. The know-how accumulated within the research and development institution is kept secret so that the institution can maintain its superiority, but is not generally sold for other information services. In addition, the new know-how has a constant pattern. If the pattern or a combination of steady solutions to certain problems were offered, general designers and users could create a new engineering analysis. JP-A-9-251385 discloses a method for the new solution. In this method, however, a way of offering a different solution to a given problem is searched out on the basis of attribute information from the past examples of problem, but the method of searching is not clear and is not based on a rule. Thus, it is less likely to get a new idea, and there is no versatility. According to this method, designers can extract rules from the past examples of problem and find a constant rule. Thus, this method is versatile, and it is likely to create a solution that the user has never thought of.

However, when the ways of offering are classified by technical field or problem, such classification can benefit the customer, but most of these methods are known. Therefore, there are the following problems: (1) a method for solving a problem cannot be immediately found, (2) a known method that has so far been taken against the problem comes to be used, and another new method is almost not likely to be created, and (3) the customer must read extra information not concerned with the customer's specialized field.

### SUMMARY OF THE INVENTION

Accordingly, the present invention proposes system and method for urging the user to take a new solution as will be described below. When the user side enters a problem, the data is sent to a server side, where it searches an actual example database or meta database associated with solutions. This meta database has actual examples of solution collected up for each of some rules into which the solutions to the past problems are arranged by considering the past problems as opposition concepts of physical or chemical laws. As an example of this meta database concerned with solutions, there is a classification of solutions based on 40 rules as described in Nikkei Mechanical Edition, “Super Art of Invention TRIZ series 3: Technique Edition, Invention Rule of 40 illustrations” (Nikkei BP Inc., 1999). This meta database is based on the laws of nature extracted from problems, and thus is capable of proposing solutions that are low use or have not been used so far depending on fields. Therefore, the present invention can solve such problems as (1) a method for solving a problem cannot be immediately found, (2) a known method that has so far been taken against the problem comes to be used, and another new method is almost not likely to be created, and so on.

The recording medium that can be read by computer, according to the invention, is responsive to data concerned with a problem, and proposes a solution to the problem. This recording medium has a function to receive data concerning the problem, a function to search storage device that has stored therein solution rules in association with the data, and a function to extract a solution corresponding to the result of having searched the solution rules. In addition, the present invention proposes system for changing the displayed information depending on the user's specialized field. In other words, the user registers the name of the company for member registration, and previously checks the names of companies, and the chief products and technical fields of the companies on the basis of the existing enterprise database. Then, the content number, actual example database search result and meta database search result suited to the corresponding company are displayed by referring to the names of companies and the products and technical fields of the companies.

### BRIEF DESCRIPTION OF THE DRAWINGS

FIG. 1 is a diagram showing a system structure for selecting an engineering technique from an engineering portal site, according to the invention.

FIG. 2 is a diagram showing one example of the structure of a problem case database.

FIG. 3 is a diagram showing one example of the structure of a problem meta database.

FIG. 4 is a diagram showing one example of solution rules.

FIG. 5 is a diagram showing one example of a content database.

FIG. 6 is a flowchart showing the procedure for selecting an engineering technique from the engineering portal site.

FIG. 7 is a diagram showing an example of the displaying of the result of having selected the engineering technique from the engineering portal site.

FIG. 8 is a diagram showing a system structure for offering the content, including an engineering technique, selected from the engineering portal site.

FIG. 9 is a flowchart showing the procedure for selecting an offer of the content, including an engineering technique, selected from the engineering portal site.

FIG. 10 is a diagram showing an example of the displaying of an image that offers the content, including an engineering technique, selected from the engineering portal site.

FIG. 11 is a diagram showing one example of the structure of a company database.

FIG. 12 is a diagram showing a system structure for offering the content suitable to the user in the engineering portal site.

FIG. 13 is a flowchart showing a selection procedure for offering the content suitable to the user in the engineering portal site.

FIG. 14 is a diagram showing a system structure for offering the content that is used for selecting an analyzer in the engineering portal site.

FIG. 15 is a flowchart showing a procedure for offering the content that is used to select an analyzer in the engineering portal site.

FIG. 16 is a flowchart showing a procedure for offering the content that is used to select an analyzer in the engineering portal site.

FIG. 17 is a diagram showing an example of the image that is used to input of the content for selecting an analyzer in the engineering portal site.

FIG. 18 is a diagram showing an example of the displaying of the result of the inputting of the content for selecting an analyzer in the engineering portal site.

FIG. 19 is a diagram showing a method for achieving a heat transmission calculation program in the engineering portal site on the Web.

FIG. 20 is a diagram showing an example of the inputted data on an image of a thermal conduction calculation program in the engineering portal site.

FIG. 21 is a diagram showing an example of the displayed result of having inputted on the thermal conduction calculation program image in the engineering portal site.

FIG. 22 is a diagram showing an example of the inputting of data and result on a material strength calculation program image in the engineering portal site.

### DESCRIPTION OF THE EMBODIMENTS

(Embodiment 1)

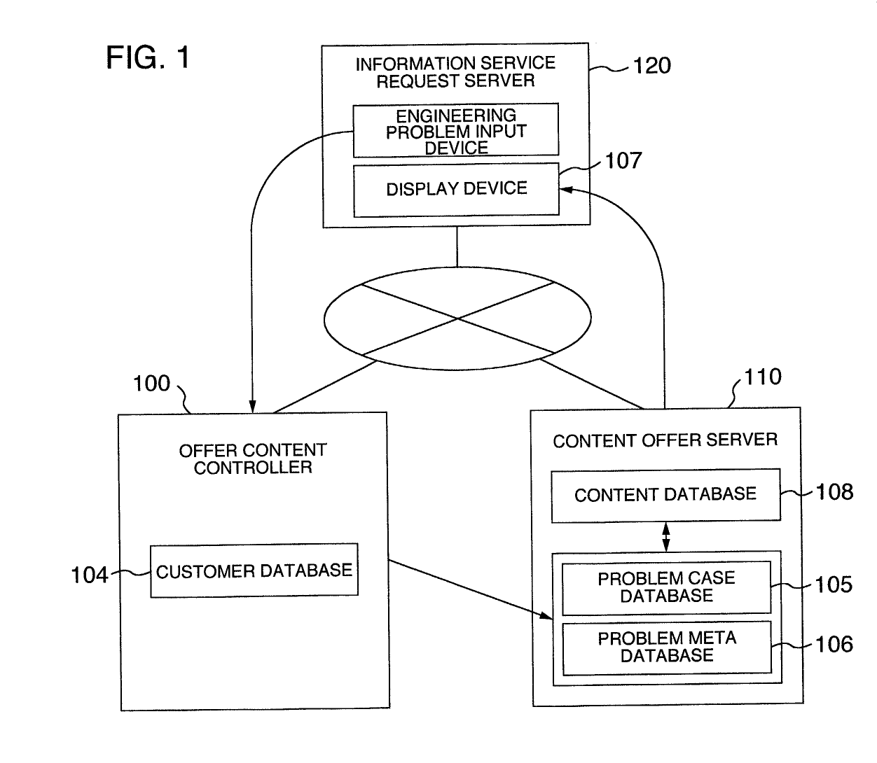

One embodiment of the invention will be described. In this embodiment, when the end user has an engineering problem, the most suitable engineering technique can be selected from an engineering portal site via an image on the Web in order to solve the problem. The selection of the engineering technique is dialogically, or interactively performed via the Web image. FIG. 1 shows a method for interactively achieving this solution on the Web. Referring to FIG. 1, there is shown an offer content controller 100 has a customer database 104 that is used to interactively certify/sort out a customer according to the ID and password that the customer has entered via an information service request apparatus 120. In addition, a content offer apparatus 110 has a problem case database 105 and a problem meta database 106 provided in order to select a solution according to the problem.

The problem case database 105 is the DB in which data of the engineering problems that occurred in the past are previously stored. In addition, the problem meta database 106 is the database that has rules extracted common to the past engineering problems after arrangement. The content database 108 is the database in which the contents offered in the engineering portal site are previously stored in association with titles.

While the offer content controller 100 and the content offer apparatus 110 are separately provided to be separate apparatus (servers) as in FIG. 1, they may be provided as a unitary body.

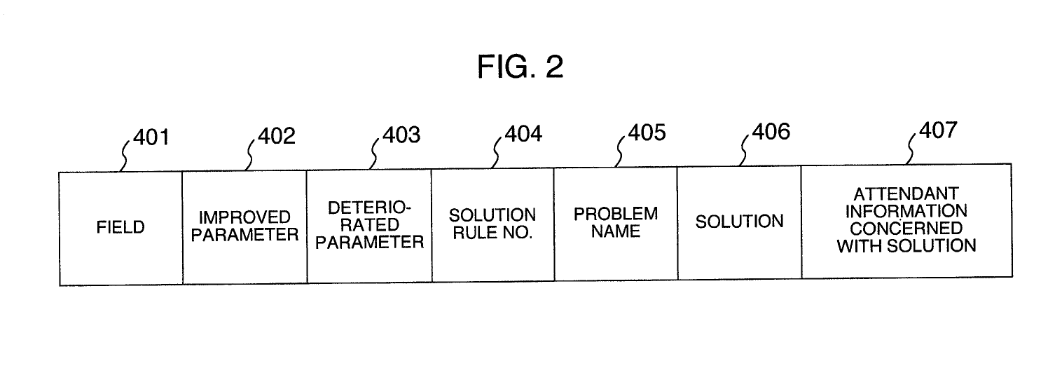

FIG. 2 shows an example of the structure of the problem case database 105. This database has (1) an engineering field 401 belonging to the corresponding problem, (2) a desired-to-improve parameter 402, (3) a deteriorated parameter 403, (4) a solution rule No., 404, (5) a problem name 405, a solution 406, and (7) attendant information 407 incidental to the solution. The engineering field 401 belonging to the problem is displayed and arranged in order for the user to be easy to see when many problem cases are found as a result of searching. The attendant information 407 incidental to the solution is the attendant information of the problem case database, such as dates on which problem cases occurred, and company names with problem cases generated.

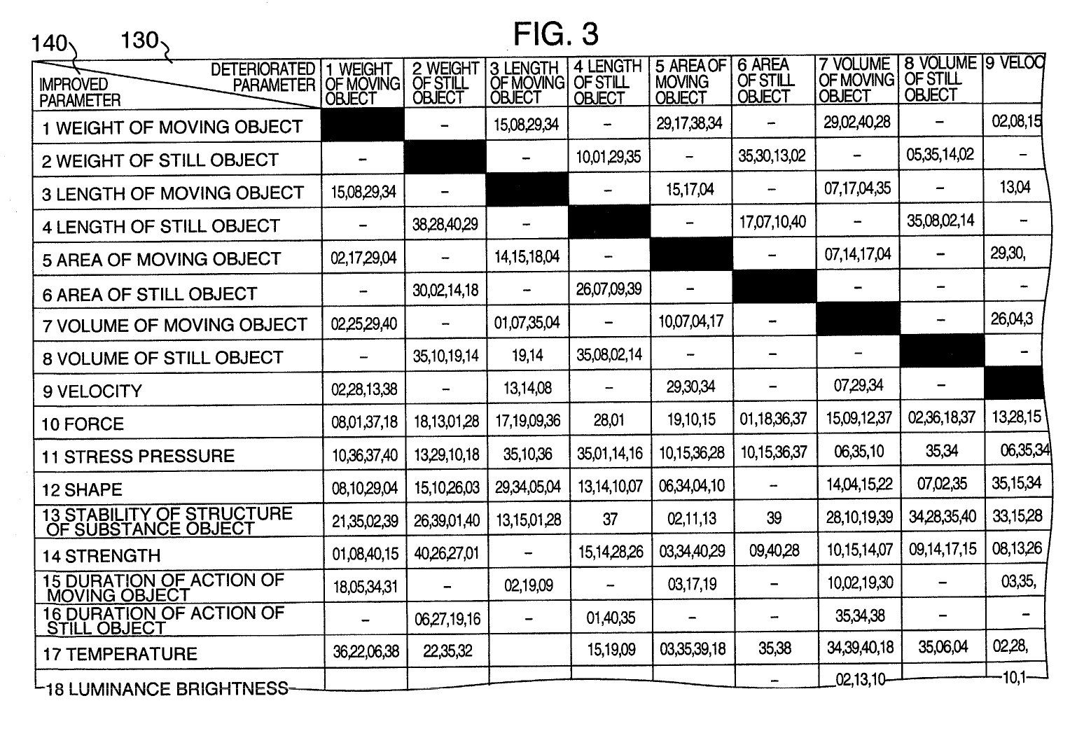

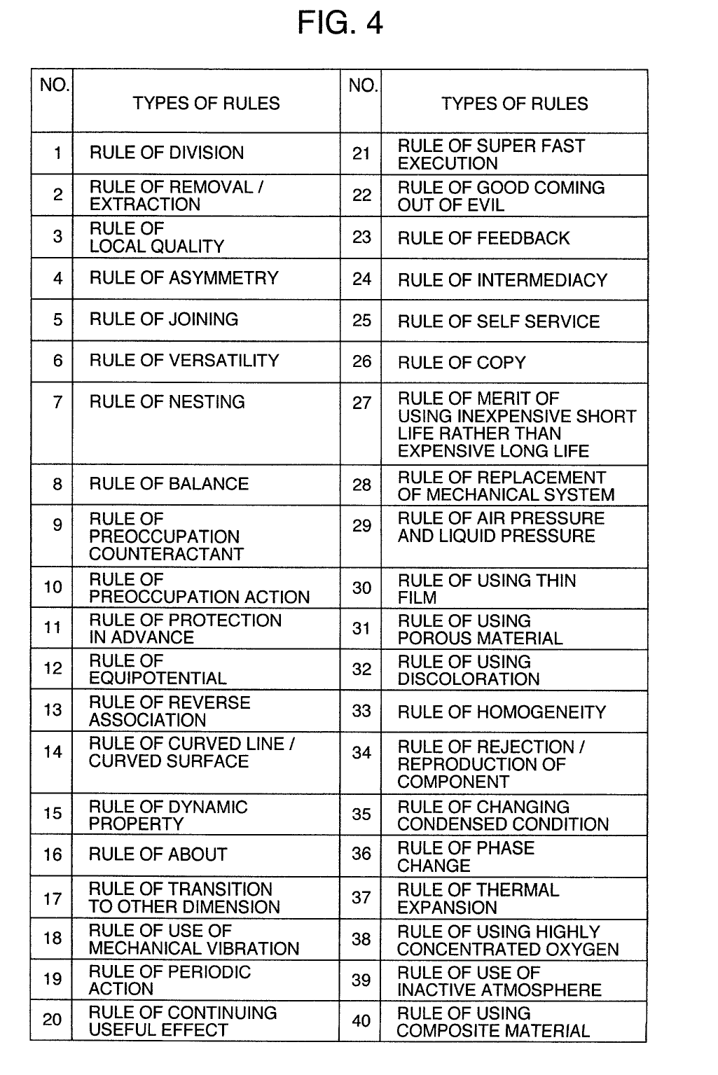

FIG. 3 shows an example of the structure of the problem meta database 106. This database has a table with the past engineering problems sorted out. The abscissa 130 of the table shows the parameters that deteriorate on the corresponding problem, and the ordinate 140 of the table indicates the parameters that are desired to improve. In the table, the solution rule numbers are given in the respective cells. Therefore, the problem meta database 106 has, in order to solve the corresponding problem, (1) the desired-to-improve parameter 402, (2) the deteriorated parameter 403, and (3) the solution rule 404 corresponding to a combination of the desired-to-improve parameter 402 and the deteriorated parameter 403 as data. Here, the numbers No. of solution rules in FIG. 3 correspond to the numbers No. in FIG. 4.

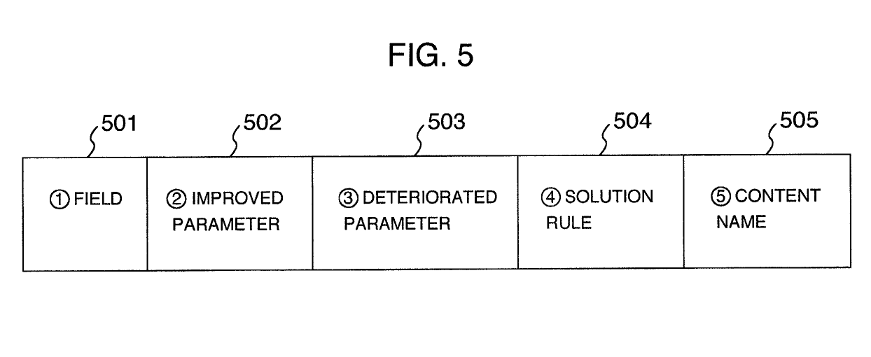

FIG. 4 shows an example of the solution rules. FIG. 5 shows an example of the content database. The content database has (1) an engineering field 501 belonging to the corresponding problem, (2) a desired-to-improve parameter 502, (3) a deteriorated parameter 503, (4) a solution rule 504 corresponding to a combination of the parameters 502, 503, and (5) a content name 505 corresponding to the combination of these parameters. The engineering field 501 of the content database is also used for the user to be easy to see the contents arranged and displayed and to look for the solution in the same field as that of the user when many contents are found as a result of searching.

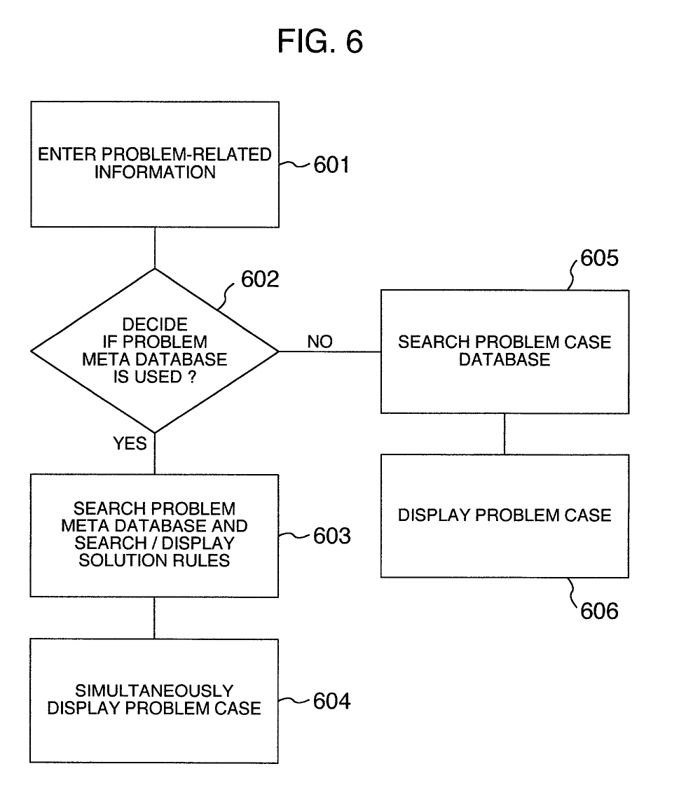

FIG. 6 is a flowchart showing the operation. The user, in step 601, enters information concerned with a problem facing, for example, a parameter associated with a characteristic that is desired to improve, and a parameter that deteriorates, via the information service server. This information is sent through the offer content controller 100 to the content offer server 110. In addition, the user, in step 602, decides if either the problem meta database or the problem case database is selected. This selection may be made by the user. If the problem meta database is selected, the problem meta database 106 within the server is searched as in the step 603, so that a solution can be found and that the resulting solution rules can be displayed. Moreover, as in step 604, problem cases corresponding to the combination of the solution rules, the parameter to be improved and the parameter to be deteriorated are found out from the database 105 and displayed.

Here, the searching device in steps 603 and 605 are programs that function in the content offer server 110. The results of searching are sent to the information service request server 120, and displayed by the function of the browser in the information service request server 120.

If the problem meta database is not selected in step 602, problem cases corresponding to the combination of the parameter to be improved and the parameter to be deteriorated are searched for in accordance with the input information in step 605, and the result is displayed in step 606.

Thus, by way of this procedure, the user can find out solutions similar to the problem the user has, from the finally displayed results of having searched the problem case database 105.

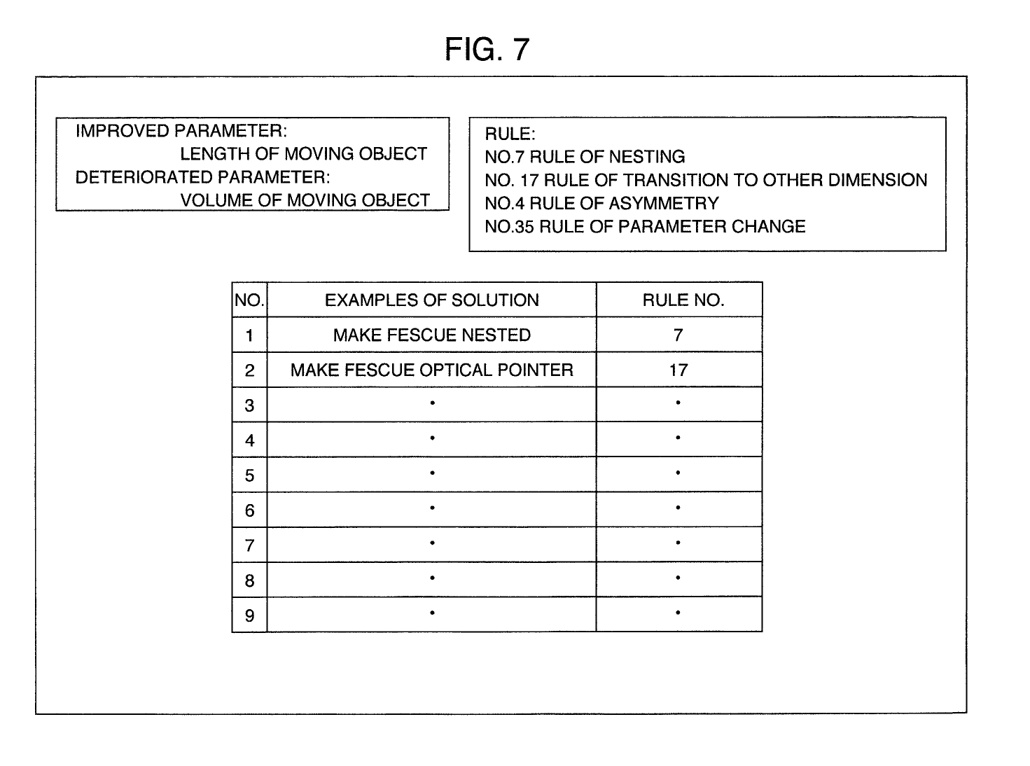

FIG. 7 shows an example of the result thus displayed. In this example, a fescue for use in the presentation by OHP (overhead projector) is tried to be made more compact without deteriorating its function. In other words, a problem occurs that the length of the fescue is desired to increase, but its volume is not wanted to increase as the requested characteristics. Here, the meta knowledge for the solution corresponds to the selected cell indicating that the volume and length of a moving object have been selected as a deteriorated parameter and a desired-to-improve parameter in the matrix shown in FIG. 3. That is, the cell includes, as solution rules, No. 7 (rule of nesting), No. 17 (rule of transition to other dimension), No. 4 (rule of asymmetry), and No. 35 (rule of parameter change). FIG. 7 shows solution rules found by searching the problem meta database 105. Moreover, the problem case database 105 is searched according to the solution rules, and case data are displayed in a table form on the Web browser on the user's terminal.

(Embodiment 2)

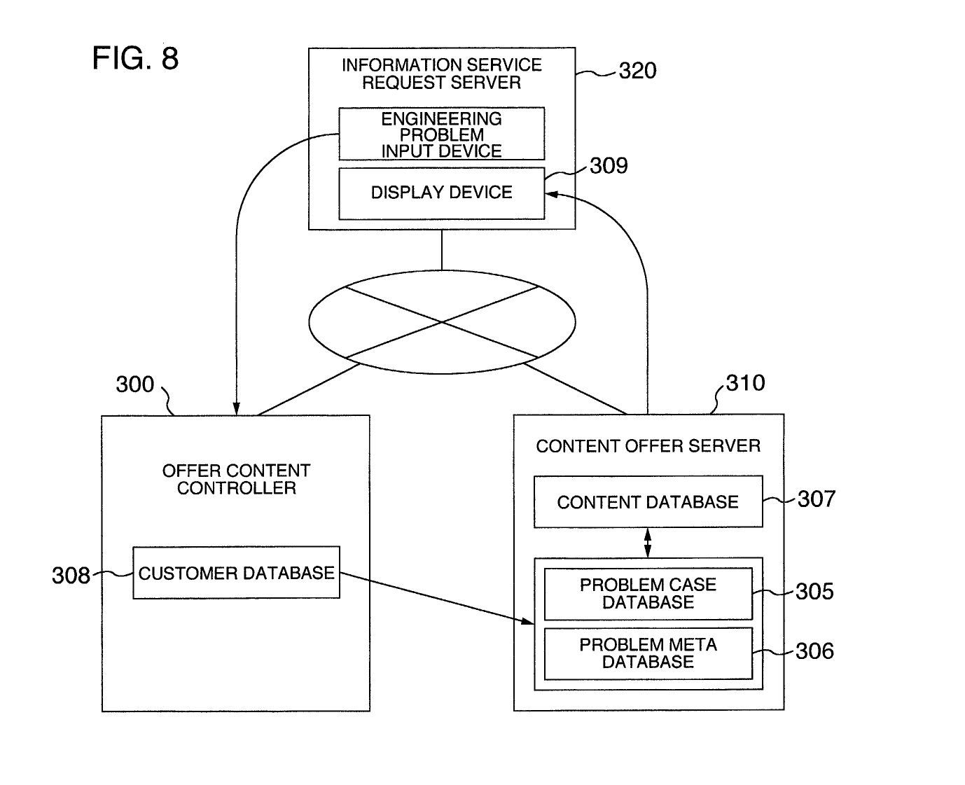

Another embodiment of the invention will be described below. This embodiment enables the end user having an engineering problem to select an engineering technique most suitable to solve the problem from the engineering portal site via the Web. The selection of the engineering technique is interactively performed by selecting contents of the engineering portal site via the Web. FIG. 8 shows a method for interactively achieving to find a solution on the Web. Referring to FIG. 8, there is shown a content offer server 310 that has a problem meta database 306, a problem case database 305 and a content database 307 provided in order to dialogically select a solution according to the problem. The function and structure of each database are the same as in the embodiment 1. These databases function as follows. The problem case database 305 or problem meta database 306 within the content offer server 310 is searched for the problem cases or solution rules in response to a request from an offer content controller 300. In addition, the content database 307 is searched for contents that can offer a solution associated with these problem cases or solution rules.

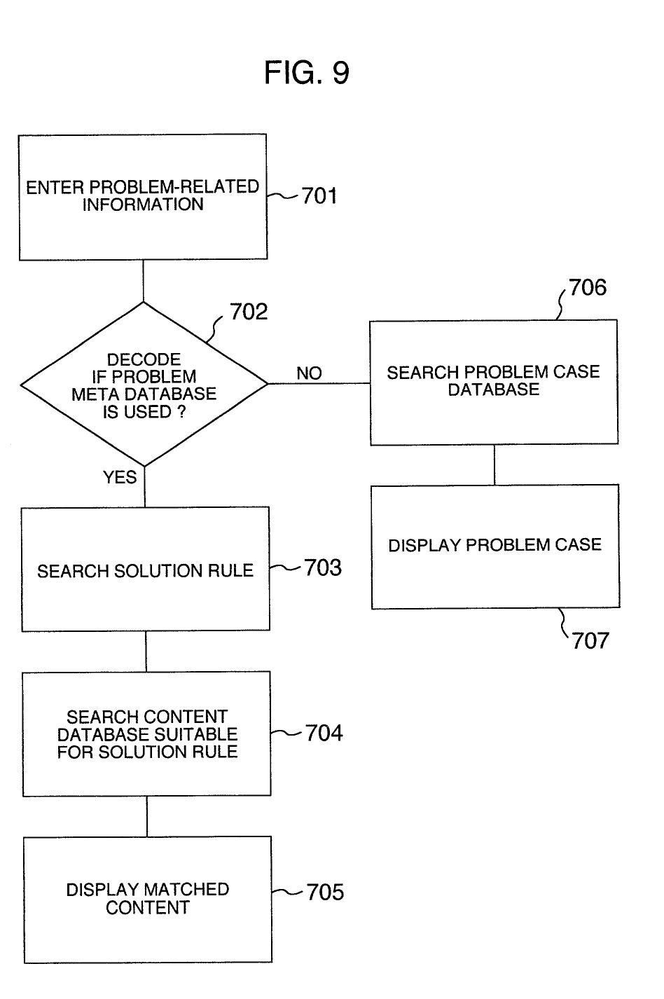

The operation will be described with a flowchart of FIG. 9. In step 701, the user enters, via the information service server, information concerned with a problem facing, for example, a parameter desired to improve and a parameter to be deteriorated. This information is sent through the offer content controller 300 to the content offer server 310. In addition, in step 702, it is decided if the problem meta database is used. If the problem meta database 306 is decided to use in step 702, the problem meta database 306 within the server is searched for a solution in step 703. When the problem meta database 306 is searched, solution rules are produced as a result of having searched. The content corresponding to a combination of these solution rules, the parameter to be improved and the parameter to be deteriorated is found out by searching the content database 307 as in step 704, and displayed as in step 705.

If the problem meta database is decided not to use in step 702, the problem case database 305 is searched with reference to the problem-related information entered in step 701, and the result is displayed in step 707.

Thus, the user can finally find out an engineering technique necessary for the solution from the displayed content.

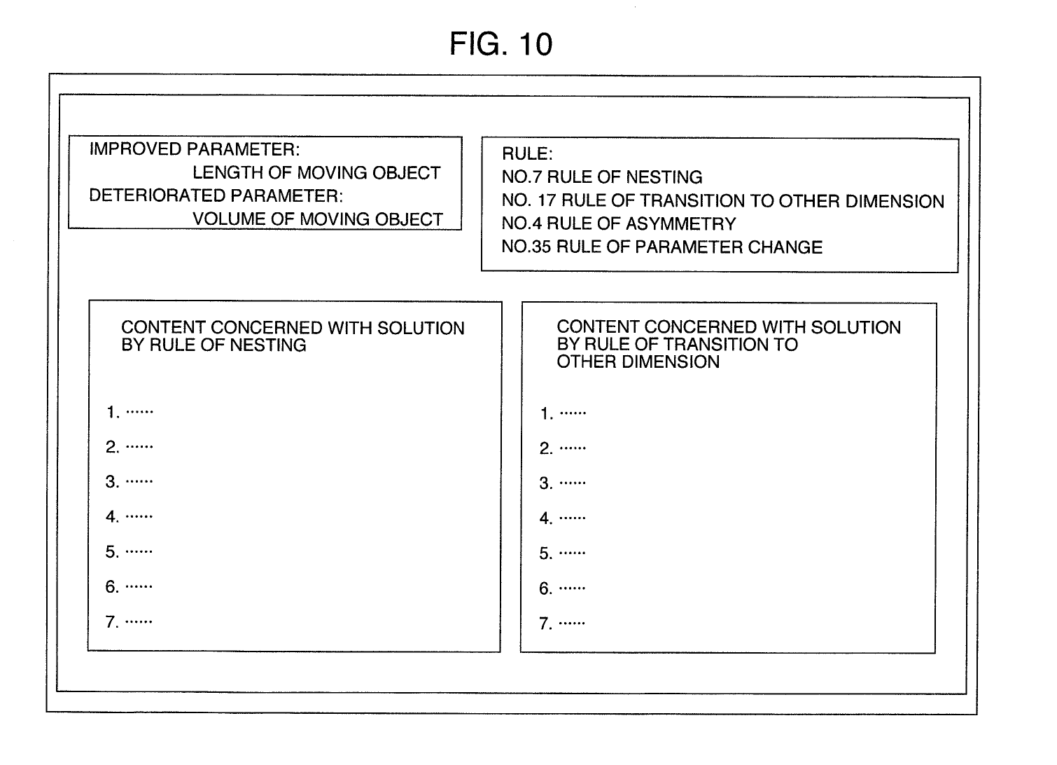

FIG. 10 shows an example of the result thus displayed. The case data searched out from the content database 307 is displayed in a table form on the Web browser on the user's terminal.

(Embodiment 3)

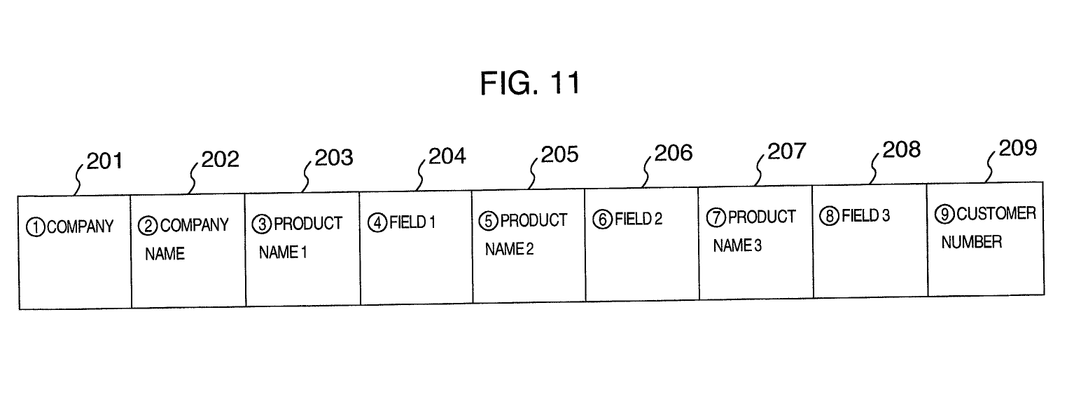

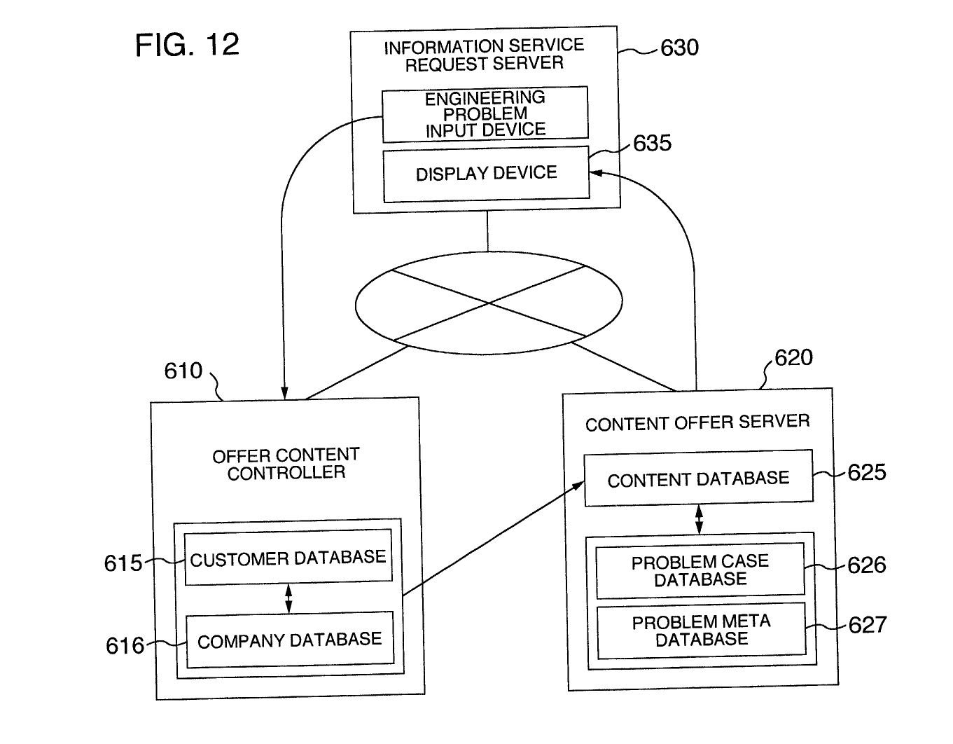

Another embodiment of the invention will be described with reference to FIG. 12. This embodiment changes the content displayed in association with the user's specialized field. In other words, this embodiment provides a company database 616 and a customer database 615 on the offer content controller side. The company database 616 is generated by registering, on the existing company database 616, the company names, and chief products and technical fields of the companies that the users entered for the membership registration. The problem case database and the problem meta database are searched according to the company name, the products and technical field of the company, the content number and content outline suitable for the company or user's request. The results of having searched are displayed. FIG. 11 shows one example of the structure of the company database 616. As illustrated, the company database has information such as (1) company No., 201, (2) company name 202, (3) product name 1, 203, (4) field 1 corresponding to the product 204, (5) product name 2, 205, (6) field 2 corresponding to the product 206, (7) product name 3, 207, (8) field 3 corresponding to the product 208, and (9) customer number belonging to the company 209.

The user sorts out the contents of the engineering portal site via the Web image, thereby interactively making the selection of the engineering technique. FIG. 12 shows a method for achieving this interactive solution on the Web. A content offer server 620 has a problem meta database 627, a problem case database 626, and a content database 625 provided so that a solution to the problem can be interactively selected. The function and structure of each database are the same as in the embodiment 1. In addition to these databases, this embodiment has the customer database 615 and company database 616 provided within the offer content controller. The company database 616 is the database that is collected on the basis of the information the customers entered, and that is concerned with the companies to which the customers belong. These databases function as follows. When the information service request server 630 sends a request, the offer content controller 610 responds the request to search the customer database 615 and company database 616 for the company to which a customer belongs, and for the technical field. Then, the content associated with the technical field is searched out from the content database 625, and displayed.

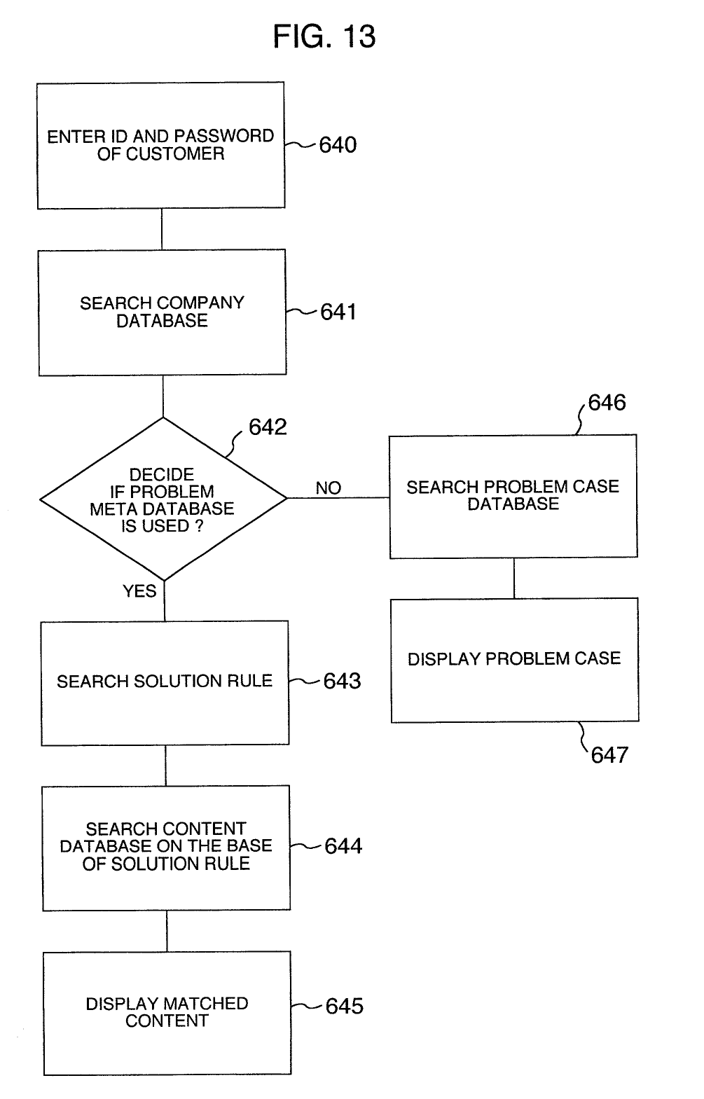

As shown in the flowchart of FIG. 13, in step 640, the user enters the ID and password for this service via the information service request server. This information is sent through the offer content controller 610 to the content offer server 620. In addition, in step 642, the user decides if he uses the problem meta database 627. If the problem meta database 627 is decided to use in step 642, the problem meta database within the server is searched for a solution in step 643. When the problem meta database 627 is searched, a solution rule is produced as a result of having searched. The content corresponding to a combination of this solution rule, a parameter to be improved, and a parameter to be deteriorated is searched out from the content database 625 as in step 644, and displayed in step 645.

If the problem meta database is decided not to use in step 642, the problem case database 626 is searched as in step 646 according to the information of the field corresponding to the products of the company to which the user belongs, which has been searched out in step 641. The result is displayed in step 647.

Thus, the user can find out an engineering technique necessary for the solution from the finally displayed content.

(Embodiment 4)

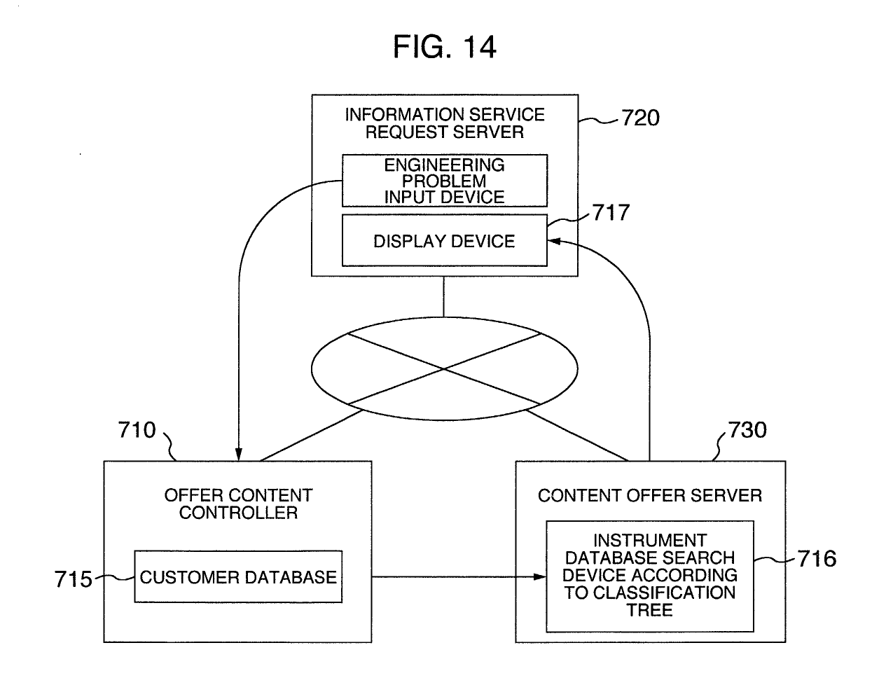

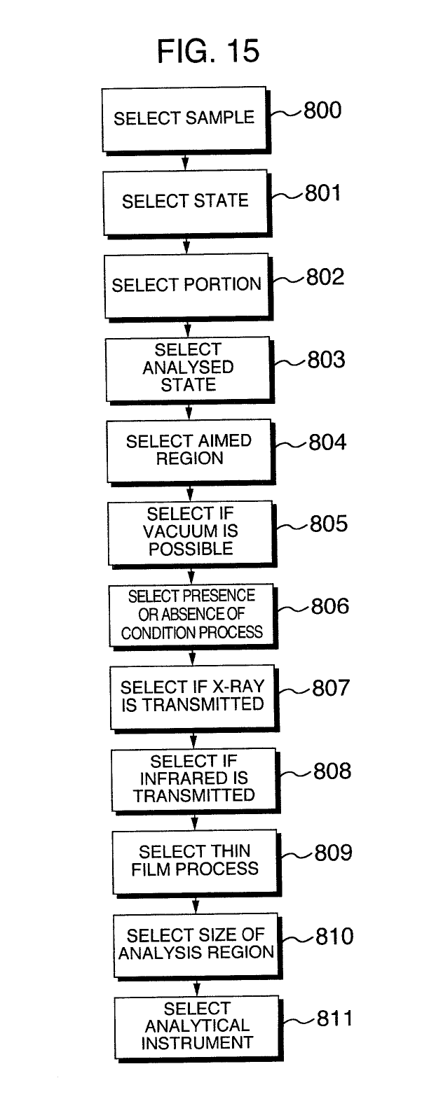

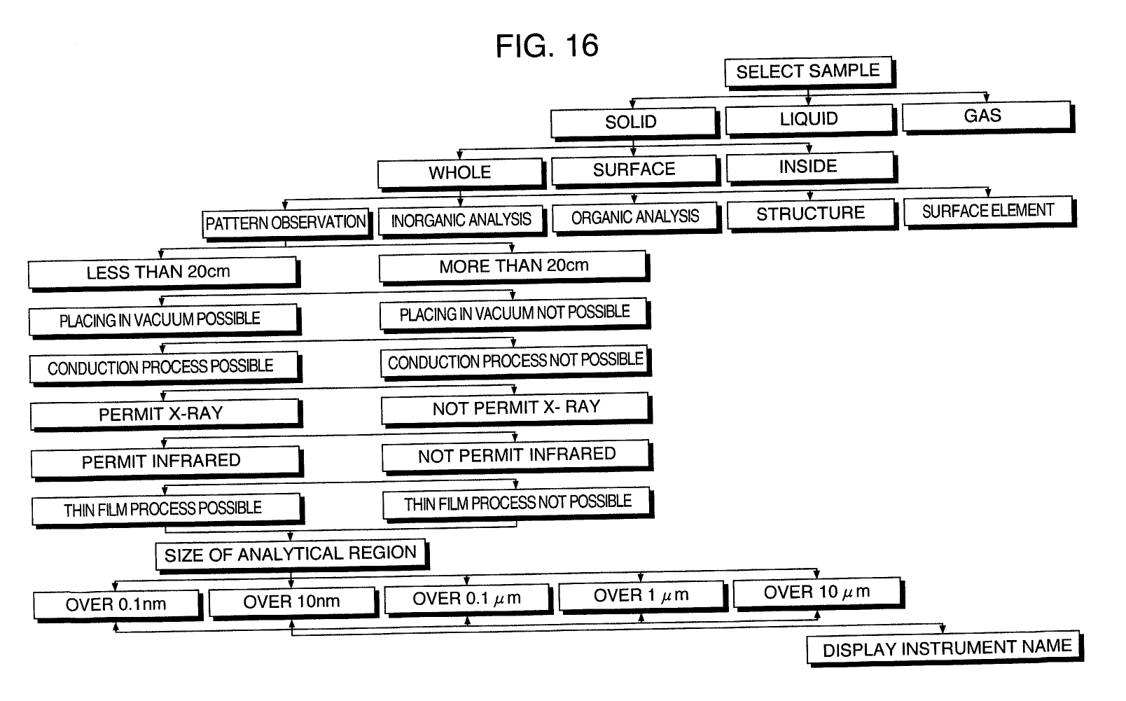

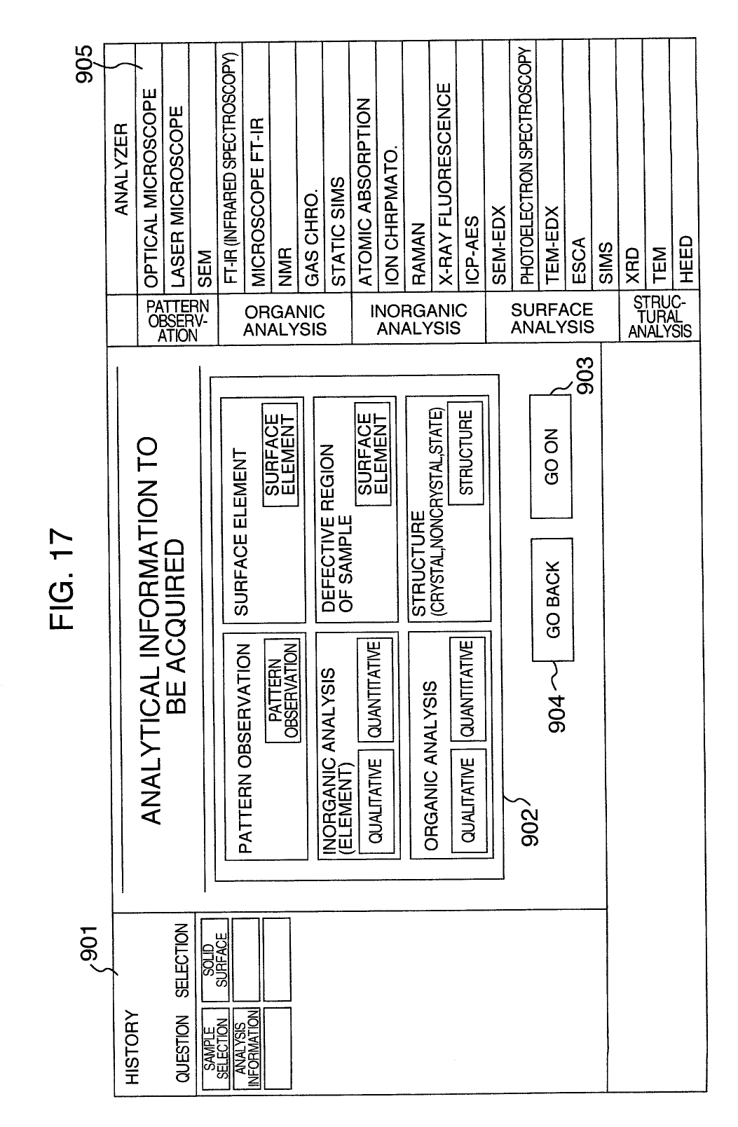

Another embodiment of the invention will be described. In this embodiment, the problem meta database 627 is interactively narrowed down unlike the embodiments 1 and 2, or searched not by the stereotyped classification of techniques, but by the classification tree based on the knowledge of the conventional use of analytical instrument. FIG. 14 shows a method for achieving this interactive solution on the Web. The server side has an analytical instrument database in order that the user can interactively select an analytical instrument. The user searches this database by following the classification tree (716). FIGS. 15 and 16 show an example of the interactive analyzer selection flow corresponding to this classification tree. FIG. 15 briefly shows the flow, and FIG. 16 shows the details of part of this flow. Although the flow diagram of FIG. 16 shows the result that “solid” has been selected at a state selection 801 of FIG. 15, “whole” at a part selection 802, and “morphologic observation” at an analysis condition selection 803, other flow sections (804˜811) can be selected similarly. That is, in this embodiment using the classification tree, while the user is choosing the information necessary for various analyses, he selects the most suitable analytical techniques and instruments from the engineering portal site on the Web in order that the end user having analytical problems can solve the problems. The contents of each instrument and description of techniques about these analytical techniques and analyzers are previously stored in a content offer server 730. The selection of analyzers is interactively made via the Web image. FIG. 17 shows an example of this interactive Web image. This image indicates that the items from the analysis of solid to the morphologic observation of surface are going to be selected by the user. The left-hand side of the image, or 901 shows the history of items selected so far, the center of the image, or 902 indicates the buttons for selection of items, the lower side “go on” button 903, when clicked, can make the user view the next selection image, and the lower side “go back” button 904, when clicked, can make the user view the previous selection image. In addition, the instruments selected are actively displayed at the time of selection on the right-hand side of the image, or 905.

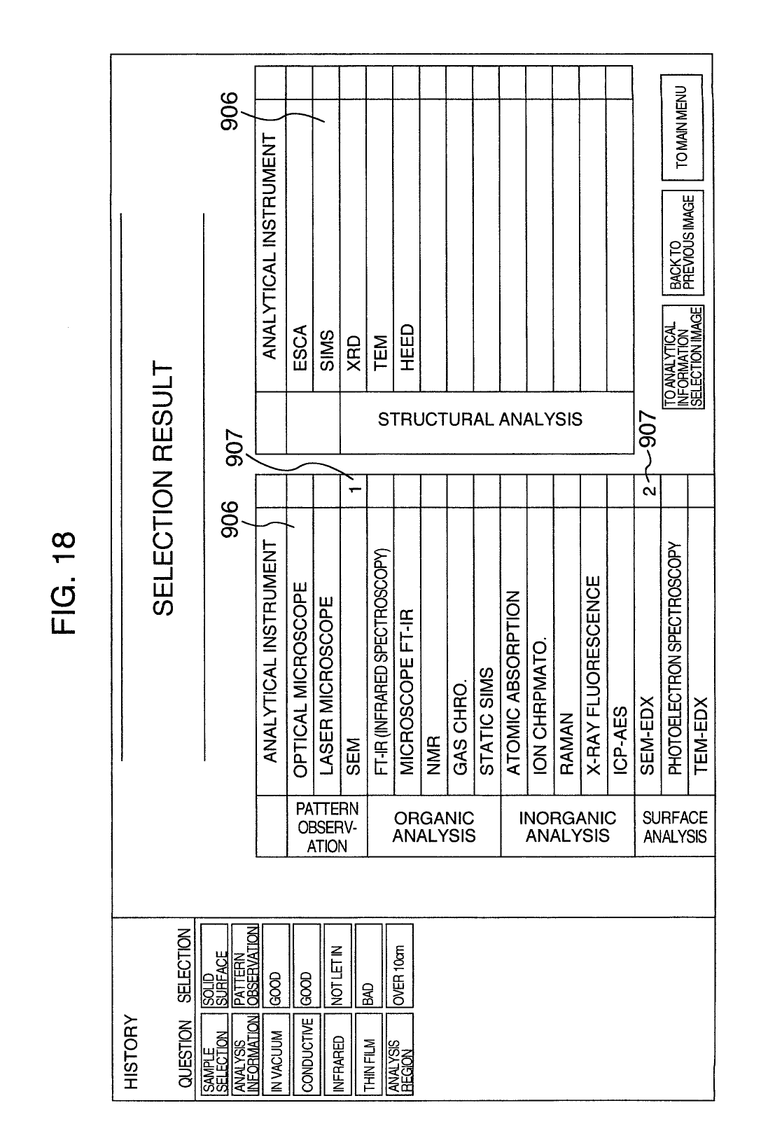

As the user follows this flow, a list of analytical instruments that the soft recommends can be finally displayed as shown in FIG. 18. This list includes a plurality of instruments 906 displayed, which are sorted in the order in which the samples cannot be destroyed with ease, and attached with priority level 907.

(Embodiment 5)

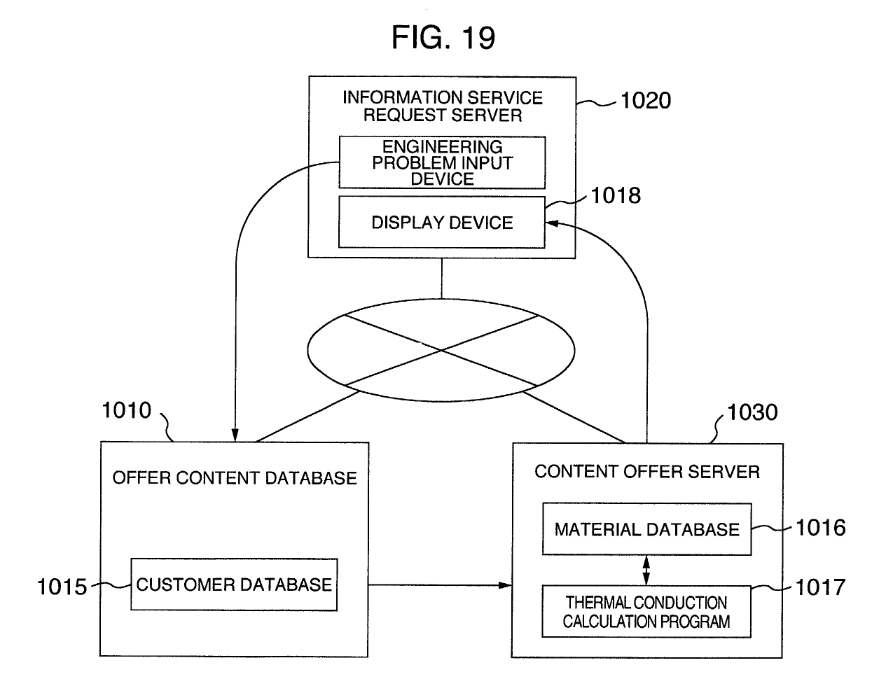

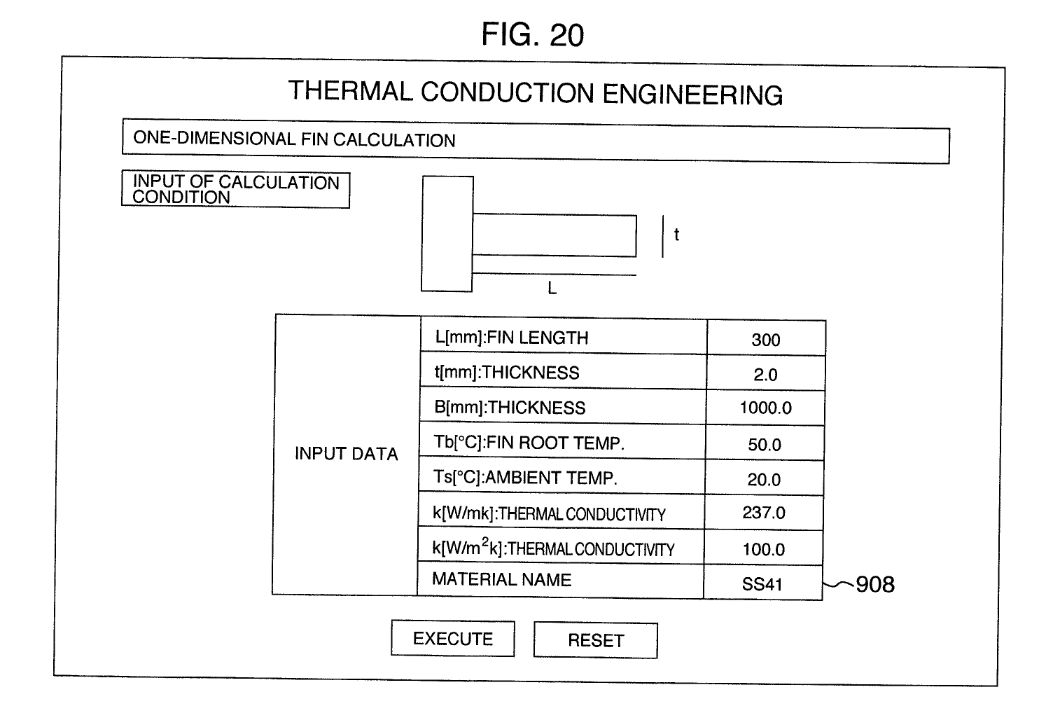

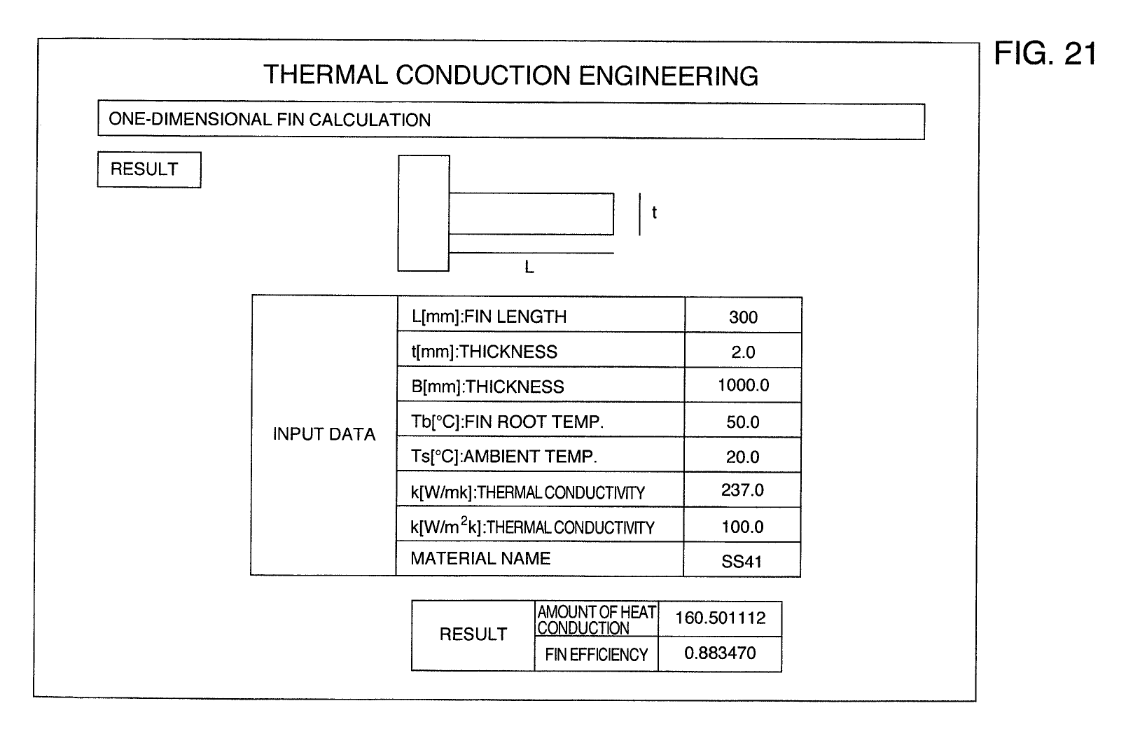

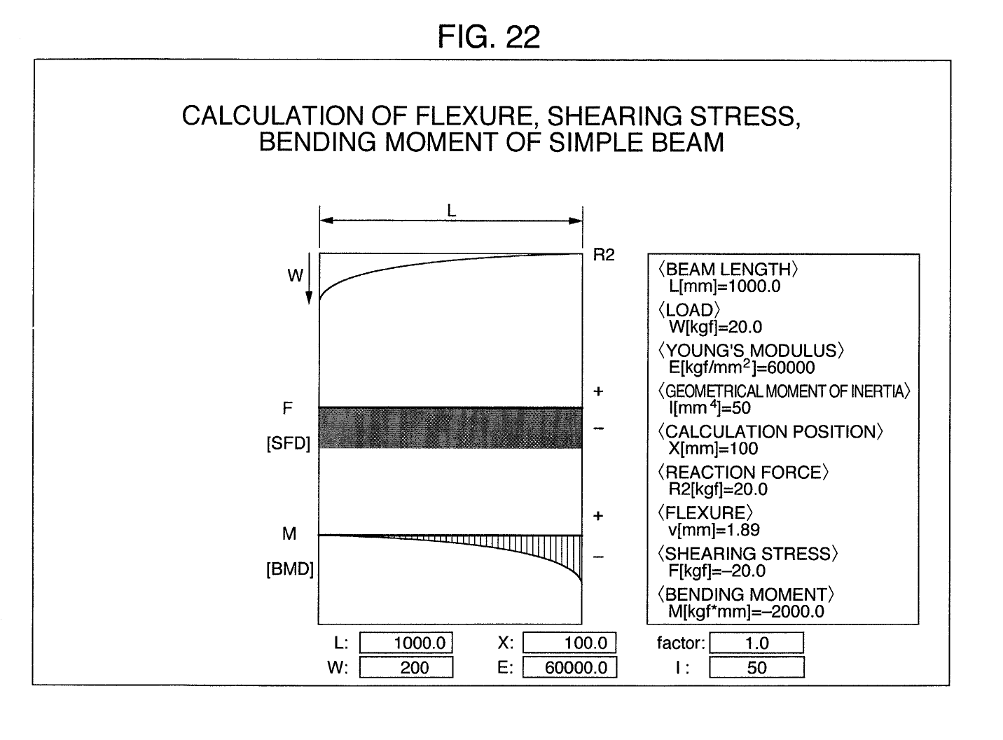

Another embodiment of the invention will be described. This embodiment enables the end user having a problem with design of a machine to make calculation of thermal conduction and material strength necessary for solving the problem via the Web in the engineering portal site. FIG. 19 shows a method for achieving an interactive solution to this heat transmission calculation on the Web. The server side has a heat transmission calculation program 1017 and a material database 1016. This embodiment makes the interactive narrowing down of information for solving a problem as follows. When the user enters the name of a material in the heat transmission calculation, the material database 1016 can be searched for a material value (such as thermal conductivity) necessary to calculate the strength of material. FIGS. 20 and 21 show an example of the Web image for this interactive heat transmission calculation, and a calculation result. As illustrated in FIG. 20, an input image is displayed where the user enters the fin length, fin thickness, fin root temperature, ambient temperature and material name, 908 necessary for heat transmission calculation. The heat transmission calculation program is executed to search the material database 1016 for material values such as thermal conductivity according to the material name, and use the values for heat transmission calculation. FIG. 22 shows an example of the Web image for this interactive material strength calculation, and a result of the calculation. The calculation result is the amount of heat transfer and fin efficiency displayed on the screen. Thus, by using this technique, it is possible that the user interactively performs various scientific calculations while viewing the Web image.

According to the above embodiments, the system that answers the question from the user can enable the user to immediately understand the solution to the problem and to be offered an information service that is likely to give the user not the known solution to the problem, but a new solution to the problem.

According to the invention, since the user having a problem can be offered specific examples that are concerned with new solution rules and the solution to the problem, the method for offering the contents can be effectively used.

What is claimed is:

1. A method for providing information at an engineering portal site, comprising the steps of:
searching a meta database including a rule extracted from actual examples or a case database regarding a solution to a problem in response to said problem from the user; and
displaying said solution to said problem from the user by use of said search result.

2. A method according to claim 1, further comprising the step of displaying a plurality of solution rules based on said meta rule searched out from said meta database in order to urge the user to think up an idea for a new solution.

3. A method according to claim 1, further comprising the step of displaying a plurality of examples of solution searched out from said case database in order to urge the user to think up an idea for a new solution.

4. A method according to claim 1, further comprising the step of displaying a plurality of solution rules based on said meta rule searched out from said meta database, and a plurality of proposed contents that offer a solution based on said solution rules in order to urge the user to think up an idea for a new solution.

5. A method according to claim 1, further comprising the step of displaying a plurality of solution rules based on said metal rule searched out from said meta database, a plurality of examples of solution searched out from said case database, and a plurality of contents that offer said solution examples in order to urge the user to think up an idea for a new solution.

6. A method according to claim 1, wherein in order that each of customers can be offered customized solutions and contents, a company database is provided that is concerned with companies which said customers belong to, and searched for each customer's information, and problems and solutions supposed for each customer are enumerated by use of said search result.

7. A method according to claim 1, wherein in order that each of customers can be offered customized solutions and contents, a company database is provided that is concerned with companies which said customers belong to, and a problem from each customer is easily solved by displaying said contents selected according to the type of said customers.

8. An information service providing system comprising:
means for accepting data about a problem sent from a demander who requests for providing an information service;
means for transmitting said accepted data to an information providing server;
means for executing processes of searching a solution database having data of solution rules by use of said data transmitted from said demander;
means for transmitting said search result from said information providing server to said demander; and
means for receiving said search result sent from said information service providing server and supplying said result to the outside.

9. A system according to claim 8, wherein said data accepting means receives data to be improved.

10. A system according to claim 9, wherein said solution database stores said data of said solution rules concerned with said problem and said received data to be improved in association with each other.

11. A recording medium that can be read by a computer, and that accepts data of a problem and provides a solution to said problem, said medium having a function to receive said data of said problem, a function to search storage device having solution rules stored in association with said data, and a function to extract a solution corresponding to the result of having searched for said solution rules.

12. A recording medium that can be read by a computer, and that accepts data of a problem and provides a solution to said problem, said medium having a function to receive said data of said problem, a function to search either first storage device having solution rules stored in association with said data or second storage device having examples of solution in association with said problem, and a function to extract a solution corresponding to the result of having searched for said solution rules.

13. A recording medium according to claim 12, wherein said function to extract said solution corresponding to said solution rules has a function to search a content database having information of solutions associated with said solution rules.
